(19) United States
(12) Patent Application Publication
(10) Pub. No.: US 2022/0291424 A1
(43) Pub. Date: Sep. 15, 2022

(54) DISPLAY SWITCHING DEVICE

(71) Applicant: OMRON Corporation, KYOTO (JP)

(72) Inventors: Masayuki SHINOHARA, Kyoto-shi (JP); Yuto MORI, Kyoto-shi (JP); Gouo KURATA, Kyoto-shi (JP); Hayato YOSHIDA, Kyoto-shi (JP); Masao MISHINA, Kyoto-shi (JP)

(73) Assignee: OMRON Corporation, KYOTO (JP)

(21) Appl. No.: 17/673,910

(22) Filed: Feb. 17, 2022

(30) Foreign Application Priority Data
Mar. 15, 2021 (JP) 2021-041191

(51) Int. Cl. G02B 3/00

(52) U.S. Cl. CPC G02B 3/0037

(57) ABSTRACT

A display switching device according to one or more embodiments is disclosed. In a display switching device according to one or more embodiments, at least one of the pixel regions receives light from a plurality of light sources included in a predetermined light source group, and the light from each of the plurality of light sources is focused by a different lens.

### CROSS-REFERENCE TO RELATED APPLICATION

This application claims priority to Japanese Patent Application No. 2021-041191 filed on Mar. 15, 2021, the contents of which are incorporated herein by reference.

### FIELD

The present disclosure relates to a display switching device.

### BACKGROUND

FIG. 36 is a schematic diagram of a related display switching device described in Patent Literature 1. As shown in FIG. 36, a display unit 100 includes multiple pixels each having two pixel regions (a triangle and a circle). Light 103 from a light source 102 passes through a lenticular lens 101 including multiple microlenses and enters seven pixels that are arranged vertically. The pixel regions (triangles or circles) to be displayed can be selected by changing the angle at which the light 103 from the light source 102 enters the lenticular lens 101 to change the focal point at which the light is focused by the lenticular lens 101. More specifically, selecting multiple triangle pixel regions causes a first pattern to appear, and selecting multiple circle pixel regions causes a second pattern to appear. The light source 102 is movable in C-direction in the figure.

FIG. 37 is a schematic diagram of a related display switching device 200 including a substrate 202, a first light source 201A for causing a display unit 204 to display a first pattern, a second light source 201B for causing the display unit 204 to display a second pattern, a lens array 203 including multiple lenses L0 to L7, and the display unit 204. The display switching device 200 can switch between displaying the first pattern and displaying the second pattern on the display unit 204 by turning on the first light source 201A or the second light source 201B.

### CITATION LIST

### Patent Literature

Patent Literature 1: Japanese Unexamined Patent Application Publication No. 2003-195216

### SUMMARY

In the related display switching device described in Patent Literature 1, the light 103 emitted from a light source 102 enters the vertically-arranged seven pixels through the lenticular lens 101. The vertically-arranged seven pixels may have difficulty in achieving display uniformity across the pixel regions (the triangles and the circles). In particular, the top and bottom pixels of the vertically-arranged seven pixels, or more specifically, the pixels receiving the light 103 entering the lenticular lens 101 at wide angles have lower light intensity in the front direction. The top and bottom pixels thus particularly have poor display uniformity across the pixel regions (the triangles and the circles), which cannot be eliminated by moving the light source 102 in C-direction in the figure.

Similarly, in the related display switching device 200 shown in FIG. 37, light emitted from one first light source 201A enters first pixel regions 205A and 205A′ in the display unit 204 through the lens array 203, and light emitted from one second light source 201B enters a second pixel region 205B in the display unit 204 through the lens array 203. The first pixel regions 205A and 205A′ and the second pixel region 205B may thus have difficulty in achieving display uniformity. For the first pixel region 205A′ in particular, light from the first light source 201A enters the lens array 203 at wide angles. A light component HA′ through the first pixel region 205A′ is less intense in the front direction than a light component HA through the first pixel region 205A and a light component HB through the second pixel region 205B. The first pixel region 205A′ has particularly poor display uniformity.

One or more embodiments are directed to a display switching device having increased display uniformity across the pixel regions.

A display switching device according to one or more embodiments is a device for switching display images by switching light illumination from a plurality of light source groups each including a plurality of light sources between the plurality of light source groups. The device may include a lens array including a plurality of lenses, and a display unit including a plurality of pixel regions. The plurality of pixel regions allows passage of light emitted from the plurality of light source groups and focused by the plurality of lenses included in the lens array. Each of the plurality of pixel regions has a transmittance corresponding to a predetermined static pattern. At least one of the pixel regions receives light from the plurality of light sources included in a predetermined light source group of the plurality of light source groups. The light from each of the plurality of light sources in the predetermined light source group is focused by a different lens of the plurality of lenses.

In the above described structure, at least one of the pixel regions receives light from the plurality of light sources included in a predetermined light source group of the plurality of light source groups. The light from each of the plurality of light sources in the predetermined light source group is focused by a different lens of the plurality of lenses. The display switching device thus may have more display uniformity across the pixel regions. The display switching device may also be larger and thinner.

In a display switching device according to one or more embodiments, the plurality of light source groups may include at least a first light source group and a second light source group. The plurality of pixel regions includes at least a first pixel region group and a second pixel region group. The first pixel region group includes a 1-1-pixel region that receives illumination of light emitted from a 1-1-light source in the first light source group and focused by a first lens in the lens array and receives illumination of light emitted from a 1-2-light source in the first light source group and focused by a second lens in the lens array. The second pixel region group includes a 2-1-pixel region that receives illumination of light emitted from a 2-1-light source in the second light source group and focused by the first lens and receives illumination of light emitted from a 2-2-light source in the second light source group and focused by the second lens.

The display switching device with the above described structure may have more display uniformity across the 1-1-pixel region and the 2-1-pixel region. The display switching device may also be larger and thinner.

In a display switching device according to one or more embodiments, the 1-1-light source and the 2-1-light source may be in a first area, and the 1-2-light source and the 2-2-light source are in a second area. The first area and the second area are adjacent to each other.

The display switching device with the above described structure may have more display uniformity across the 1-1-pixel region and the 2-1-pixel region. The display switching device may also be larger and thinner.

In a display switching device according to one or more embodiments, the first lens and the second lens may be adjacent to each other.

The display switching device with a structure as described herein may have more display uniformity across the 1-1-pixel region and the 2-1-pixel region. The display switching device may also be larger and thinner.

In a display switching device according to one or more embodiments, the lens array may include the plurality of lenses arranged in a two-dimensional matrix. At least one of the pixel regions receives illumination of light focused by four of the plurality of lenses adjacent to each other.

The display switching device with the disclosed structure may have more display uniformity across the pixel regions with multiple relatively small optical systems.

In a display switching device according to one or more embodiments, the lens array may have an area larger than an area receiving the plurality of light sources.

The disclosed structure may allow multiple display switching devices to be joined together without additional bezels (in a bezel-less manner). The display switching device may be thus large and bezel-less.

In a display switching device according to one or more embodiments, the plurality of light sources may include a virtual light source generated by a mirror or a lens using a portion of light from a real light source that actually emits light.

The display switching device with the disclosed structure may use fewer real light sources and is energy-saving.

The display switching device according to one or more embodiments may further include a light shield that shields a part of an area defined by an emission angle of light emitted from a light source of the plurality of light sources.

The display switching device with the disclosed structure may block light entering at wide angles with the light shield, thus avoiding image quality degradation resulting from aberration.

In a display switching device according to one or more embodiments, the predetermined light source group may include the plurality of light sources having different intensities.

The display switching device with the disclosed structure may have more display uniformity across the pixel regions.

In a display switching device according to one or more embodiments, the predetermined light source group may include the plurality of light sources having different emission colors.

The display switching device with the disclosed structure may use multiple colors in the pixel regions and may display a new appearance.

In a display switching device according to one or more embodiments, the plurality of lenses may receive illumination of collimated light.

The display switching device with the disclosed structure may avoid image quality degradation resulting from aberration and may have more display uniformity across the pixel regions.

A display switching system according to one or more embodiments may include a plurality of the display switching devices according to any one of the above aspects. The plurality of display switching devices may include the display units adjacent to each other.

The display switching system with the disclosed structure may allow display of larger images or images with any shapes.

A switch according to one or more embodiments may include the display switching device according to one or more embodiments described above. The switch may detect a user operation on the display switching device.

The switch with the disclosed structure may have more uniformity across the pixel regions.

An electrical apparatus according to one or more embodiments includes the switch. The electrical apparatus may be operable with the switch.

The electrical apparatus with the disclosed structure includes the switch having more display uniformity across the pixel regions.

A display switching device according to one or more embodiments may have more display uniformity across the pixel regions.

### BRIEF DESCRIPTION OF THE DRAWINGS

FIG. 1 is a schematic diagram illustrating a display switching device according to a first embodiment or embodiments.

FIG. 2 is a schematic diagram illustrating a display unit included in a display switching device according to a first embodiment or embodiments.

FIG. 3 is a diagram illustrating a display unit included in a display switching device according to a first embodiment, showing switching display examples.

FIG. 4 is a diagram illustrating to describe a correspondence of light sources to a display unit and a lens array for a display switching device according to a first embodiment or embodiments.

FIG. 5 is a diagram illustrating to describe an optical effect produced by a display switching device according to a first embodiment, such as is shown in FIG. 1.

FIG. 6 is a diagram illustrating a plan view of a display unit in a display switching device according to a first embodiment or embodiments, such as is shown in FIG. 1, with light passing through a display unit.

FIG. 7 is a diagram illustrating to describe display uniformity across a display unit for light from a single light source passing through pixel regions in a display switching device according to a first embodiment or embodiments.

FIG. 8 is a diagram illustrating to describe display uniformity across a display unit for light from two light sources passing through a pixel regions in a display switching device according to a first embodiment or embodiments.

FIG. 9 is a schematic diagram illustrating a display switching device according to a modification of a first embodiment or embodiments.

FIG. 10 is a diagram illustrating a plan view of a lens array included in a display switching device according to a first embodiment or embodiments.

FIG. 11 is a diagram illustrating a plan view of another example lens array for a display switching device according to a first embodiment or embodiments.

FIG. 12 is a schematic diagram illustrating a display switching device according to another modification of a first embodiment or embodiments.

FIG. 13 is a schematic diagram illustrating a display switching device according to still another modification of a first embodiment or embodiments.

FIG. 14 is a diagram illustrating a plan view of still another example lens array included in to display switching device according to a first embodiment or embodiments.

FIG. 15 is a diagram illustrating other example light sources for a display switching device according to a first embodiment or embodiments.

FIG. 16 is a diagram illustrating still other example light sources for a display switching device according to a first embodiment or embodiments.

FIG. 17 is a diagram illustrating a schematic plan view of a lens array included in a display switching device according to a second embodiment or embodiments.

FIG. 18 is a schematic diagram illustrating a display switching device according to a second embodiment or embodiments.

FIG. 19 is a diagram illustrating example display appearing on a pixel regions in a display switching device according to a second embodiment or embodiments, with multiple light sources that emit different colors of light.

FIG. 20 is a diagram illustrating to describe display uniformity across pixel regions in a display switching device according to a second embodiment or embodiments, with multiple light sources that emit light at a same intensity.

FIG. 21 is a diagram illustrating to describe display uniformity across a pixel regions in a display switching device according to a second embodiment or embodiments, with multiple light sources that emit light at different intensities.

FIG. 22 is a schematic diagram illustrating a display switching device according to a first modification of a second embodiment or embodiments.

FIG. 23 is a schematic diagram illustrating a display switching device according to a second modification of a second embodiment or embodiments.

FIG. 24 is a schematic diagram illustrating a display switching device according to a third modification of a second embodiment or embodiments.

FIG. 25 is a schematic diagram illustrating a display switching device according to a fourth modification of a second embodiment or embodiments.

FIG. 26 is a schematic diagram illustrating a display switching device according to a fifth modification of a second embodiment or embodiments.

FIG. 27 is a schematic diagram illustrating a display switching device according to a third embodiment or embodiments.

FIG. 28 is a diagram illustrating another example light-shield wall for a display switching device according to a third embodiment or embodiments.

FIG. 29 is a schematic diagram illustrating a display switching system according to a fourth embodiment or embodiments.

FIG. 30 is a schematic diagram illustrating a display switching system according to a modification of a fourth embodiment or embodiments.

FIG. 31 is a schematic diagram illustrating a display switching system according to another modification of a fourth embodiment or embodiments.

FIG. 32 is a diagram illustrating a schematic plan view of a bezel-less display switching system.

FIG. 33 is a diagram illustrating a cross-sectional view of a bezel-less display switching system, such as is shown in FIG. 32.

FIG. 34 is a diagram illustrating a schematic plan view of a display switching system with a bezel.

FIG. 35 is a diagram illustrating a schematic diagram of a switch according to a fifth embodiment or embodiments including a display switching device.

FIG. 36 is a schematic diagram illustrating a related display switching device described in Patent Literature 1.

FIG. 37 is a schematic diagram illustrating a related display switching device 200.

### DETAILED DESCRIPTION

One or more embodiments of the present disclosure will now be described with reference to drawings. For ease of explanation, the components with the same functions as the components described in a specific embodiment are given the same reference numerals and will not be described.

### First Embodiment

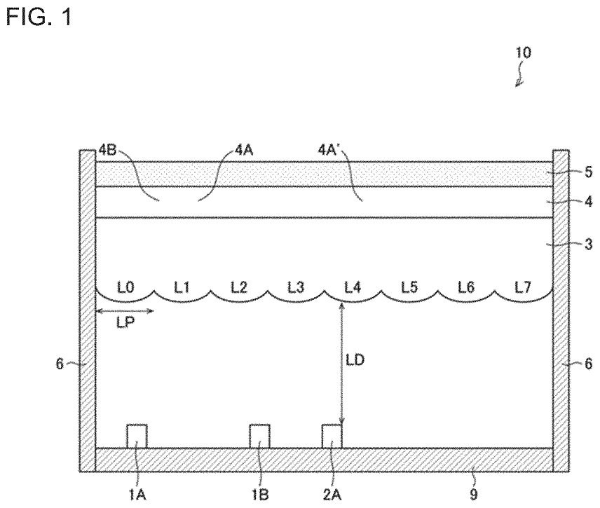

FIG. 1 is a schematic diagram of a display switching device 10 according to a first embodiment. As shown in FIG. 1, the display switching device 10 includes, from bottom to top in the figure, a substrate 9, multiple light sources 1A, 1B, and 2A, a lens array 3 including multiple microlenses L0 to L7, a display unit 4 including multiple pixel regions 4A and 4A′ for displaying a first pattern and multiple pixel regions 4B for displaying a second pattern, and a light diffuser 5. The lens array 3, the display unit 4, and the light diffuser 5 are supported by a housing 6, which is joined to the substrate 9 receiving the light sources 1A, 1B, and 2A to be the display switching device 10. The display switching device 10 may further include a protective layer over the light diffuser 5 for damage prevention.

At least the housing 6 or the substrate 9 may be formed from a light-absorbing material. A structure using light-absorbing material reduces the likelihood that light reflected by the lens array 3 or the display unit 4 again passes through the lens array 3 and the display unit 4 to be viewed by a user. Use of light-absorbing material in a structure also reduces the likelihood that the internal reflection of ambient light causes the image on the pixel regions 4A, 4A′, and 4B in the display unit 4 to appear faintly without the light sources 1A, 1B, and 2A being turned on.

In the present embodiment or embodiments, the light sources 1A, 1B, and 2A in the display switching device 10 are point light-emitting diodes (LEDs) (e.g., RGB LEDs). However, the light sources 1A, 1B, and 2A may be of any type such as light guide rods or a light guide that allows emission of light in predetermined regions alone (described later). The light sources may emit laser beams. An RGB LED includes a package of a red LED, a green LED, and a blue LED as a single light source. The brightness of each color of the LED is separately controllable. In the present embodiment or embodiments, the display switching device 10 includes four light sources in a first light source group including the light sources 1A and 2A and four light sources in a second light source group including the light source 1B. In some embodiments, the display switching device 10 may include any number of light sources of any size at any distance from one another as appropriate.

In the present embodiment or embodiments, the lens array 3 has microlenses L0 to L7 with a lens pitch LP of 0.25 mm. The microlenses L0 to L7 in the lens array 3 each are 0.5 mm in the thickest portion. The lens array 3 has a refractive index of 1.5 and a minimum distance LD of 30 mm between the microlenses L0 to L7 in the light sources 1A, 1B, and 2A. However, the lens array 3 may have any number of microlenses with any lens pitch LP, any thickness, any refractive index, and any minimum distance LD between the microlenses and the light sources as appropriate.

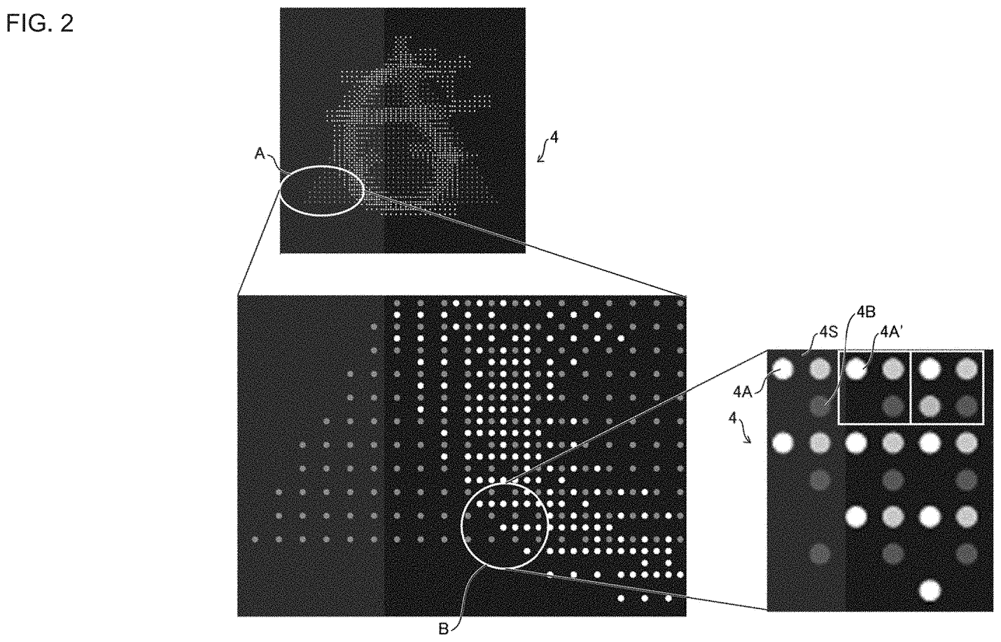

FIG. 2 is a schematic diagram of the display unit 4 included in the display switching device 10.

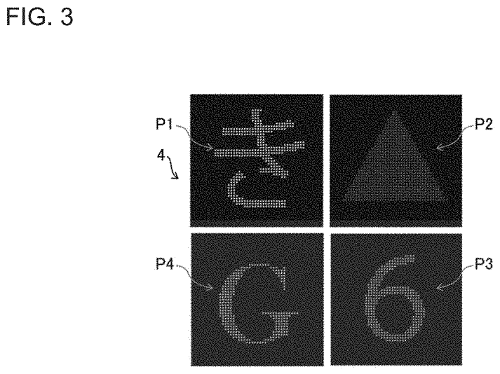

FIG. 3 is a diagram of the display unit 4 included in the display switching device 10 showing switching display examples.

As shown in FIG. 2, the display unit 4 displays predetermined patterns such as the first pattern and the second pattern in a switchable manner. FIG. 2 includes an enlarged view of portion A in the display unit 4 and an enlarged view of portion B in the enlarged view of portion A in the display unit 4. The display unit 4 includes multiple pixel regions 4A and 4A′ for displaying a first pattern P1 shown in FIG. 3 (Japanese hiragana character “ki” in the present example), multiple pixel regions 4B for displaying a second pattern P2 shown in FIG. 3 (a triangle pattern Δ in the present example), and a portion 4S other than the pixel regions 4A, 4A′, and 4B. The pixel regions 4A, 4A′, and 4B are openings to allow passage of light from the light sources 1A, 1B, and 2A and display the first pattern P1 or the second pattern P2. The portion 4S other than the pixel regions 4A, 4A′, and 4B serves as a mask with a lower transmittance of light from the light sources 1A, 1B, and 2A than the pixel regions 4A, 4A′, and 4B. The portion 4S other than the pixel regions 4A, 4A′, and 4B may be, for example, a highly light-shielding black matrix. However, the portion 4S may be formed from any material that achieves a lower transmittance of light from the light sources 1A, 1B, and 2A than the pixel regions 4A, 4A′, and 4B. The display unit 4 may be located on a substrate that transmits visible light. In the present embodiment or embodiments, the display unit 4 includes, for example, a single black matrix layer. The above described structure is not limited to the present example. For example, the display unit 4 may include two layers, which may include a first layer as a lower layer nearer the light sources 1A, 1B, and 2A and a second layer as an upper layer. The first layer may include multiple openings or transmission regions with a predetermined transmittance to allow passage of light to the pixel regions 4A, 4A′, and 4B included in the second layer. The second layer, which is the upper layer farther from the light sources 1A, 1B, and 2A, includes the pixel regions 4A, 4A′, and 4B.

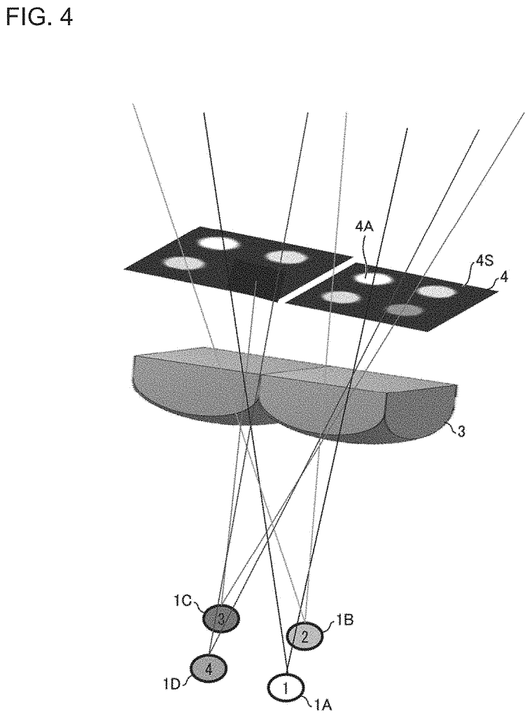

FIG. 4 is a diagram describing the correspondence of light sources to a display unit and a lens array for the display switching device according to the first embodiment.

As described above in the present embodiment or embodiments, the first pattern P1 shown in FIG. 3 is displayed with the pixel regions 4A and 4A′, and the second pattern P2 shown in FIG. 3 is displayed with the pixel regions 4B. However, the above described structure is not limited to the present example. As shown in FIG. 4, in addition to the light sources 1A and 2A included in the first light source group and the light source 1B included in the second light source group, a light source 1C included in a third light source group and a light source 1D included in a fourth light source group may be used to switch display between patterns including a third pattern P3 and a fourth pattern P4 in addition to the first pattern P1 and the second pattern P2 as shown in FIG. 3.

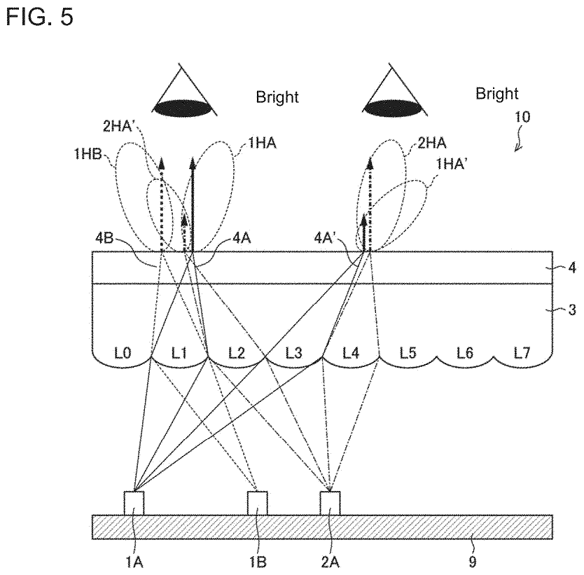

FIG. 5 is a diagram describing an optical effect produced by the display switching device 10 according to the first embodiment shown in FIG. 1.

The display switching device 10 switches the display images by switching between light illumination from the first light source group including the light source 1A and the light source 2A and light illumination from the second light source group including multiple light sources such as the light source 1B.

In the display switching device 10, light from the light source 1A in the first light source group is focused by the microlens L1 in the lens array 3 and passes through the pixel region 4A (first pixel region) in the display unit 4 and is also focused by the microlens L3 in the lens array 3 and passes through the pixel region 4A′ (first pixel region) in the display unit 4. Light from the light source 2A in the first light source group is focused by the microlens L2 in the lens array 3 and passes through the pixel region 4A (first pixel region) in the display unit 4 and is also focused by the microlens L4 in the lens array 3 and passes through the pixel region 4A′ (first pixel region) in the display unit 4. Light from the light source 1B in the second light source group is focused by the microlens L1 in the lens array 3 and passes through the pixel region 4B (second pixel region) in the display unit 4.

As described above, in the display switching device 10, each of the pixel region 4A (first pixel region) and the pixel region 4A′ (first pixel region) receives light from the light source 1A and light from the light source 2A in the first light source group focused by different microlenses. Accordingly, the display uniformity of the pixel region 4A (first pixel region) and the pixel region 4A′ (first pixel region) may be improved. The luminance uniformity between the pixel region 4A (first pixel region) and the pixel region 4A′ (first pixel region) may also be improved. The display switching device 10 can thus be larger and thinner.

As shown in FIG. 5, for the pixel region 4A, light from the light source 2A in the first light source group enters the microlens L2 in the lens array 3 at wide angles. A light component 2HA′ through the pixel region 4A is thus less intense in the front direction and degrades display uniformity. The display switching device 10 also causes light from the light source 1A in the first light source group to be focused onto the pixel region 4A by the microlens L1 in the lens array 3. A light component 1HA through the pixel region 4A is relatively intense in the front direction and improves the display uniformity across the pixel region 4A.

As shown in FIG. 5, for the pixel region 4A′, light from the light source 1A in the first light source group enters the microlens L3 in the lens array 3 at wide angles. A light component 1HA′ through the pixel region 4A′ is thus less intense in the front direction and degrades display uniformity. The display switching device 10 also causes light from the light source 2A in the first light source group to be focused onto the pixel region 4A′ by the microlens L4 in the lens array 3. A light component 2HA through the pixel region 4A′ is relatively intense in the front direction and improves the display uniformity across the pixel region 4A′.

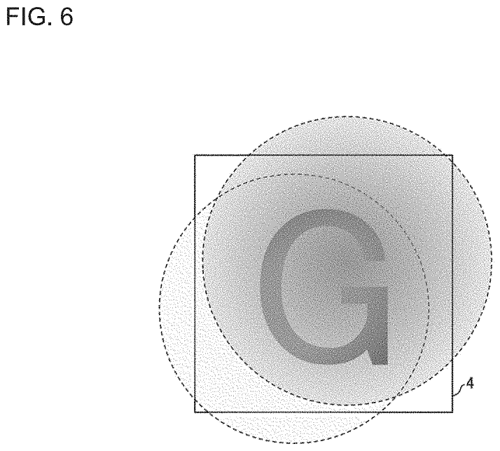

FIG. 6 is a plan view of the display unit 4 in the display switching device 10, with light passing through the display unit 4.

As shown in FIG. 6, the display unit 4 in the display switching device 10 performs display with the pixel regions 4A and 4A′ illuminated with multiple light sources in the first light source group. The pixel regions 4A and 4A′ thus have more display uniformity.

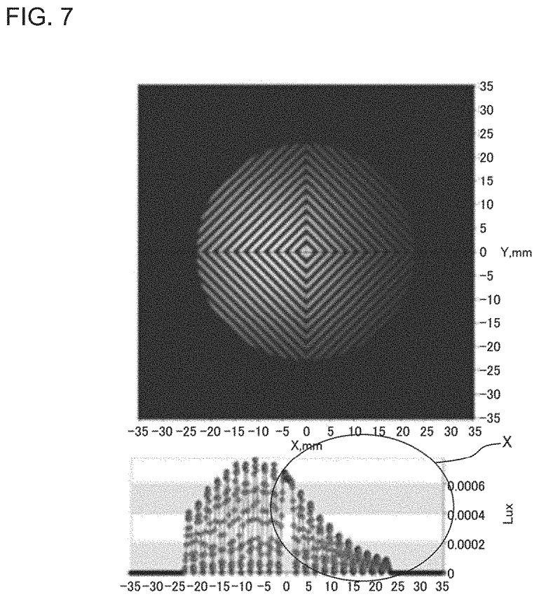

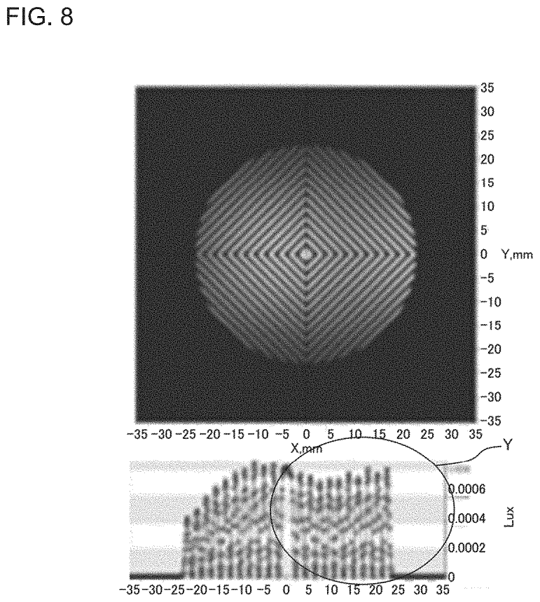

FIG. 7 is a diagram describing display uniformity across the display unit 4 for light from the single light source 1A passing through the pixel regions 4A and 4A′ in the display switching device 10. FIG. 8 is a diagram describing display uniformity across the display unit 4 for light from the two light sources 1A and 2A passing through the pixel regions 4A and 4A′ in the display switching device 10. Comparison of portion X in a circle in FIG. 7 with portion Y in a circle in FIG. 8 indicates that the display unit 4 for which light from the two light sources 1A and 2A passes through the pixel regions 4A and 4A′ as in the display switching device 10 notably has more display uniformity, or in other words, more luminance uniformity.

In the present embodiment or embodiments, as shown in FIG. 5, the pixel region 4B (second pixel region) receives light from the light source 1B in the second light source group focused by the microlens L1 in the lens array 3. A light component 1HB through the pixel region 4B is relatively intense in the front direction. In some embodiments, as described later, the pixel region 4B (second pixel region) may also receive light from two light sources focused by different microlenses included in the lens array 3, in the same manner as for the pixel region 4A (first pixel region) and the pixel region 4A′ (first pixel region) described above.

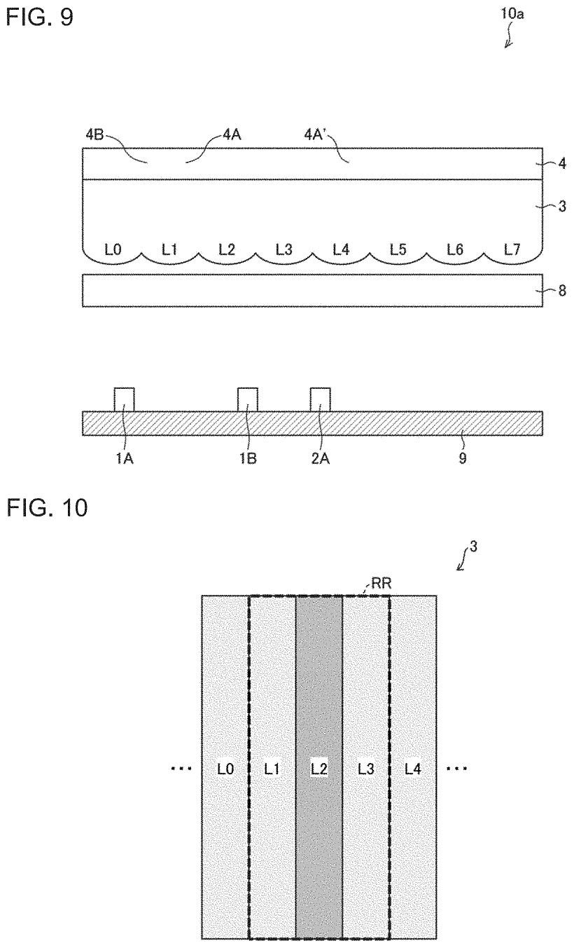

FIG. 9 is a schematic diagram of a display switching device according to a modification of the first embodiment.

A display switching device 10a shown in FIG. 9 further includes a collimator lens 8 between the light sources 1A, 1B, and 2A and the lens array 3. The collimator lens 8 collimates light from the light sources 1A, 1B, and 2A before the light enters the microlenses L0 to L7 in the lens array 3.

The display switching device 10a with the above described structure can avoid image quality degradation resulting from aberration and has more display uniformity across the pixel regions 4A and 4A′.

In the present embodiment or embodiments, the display switching device 10a includes the collimator lens 8. However, the collimator lens 8 may be replaced by any other component that can collimate light from the light sources 1A, 1B, and 2A, such as a Fresnel lens, a collimator mirror, a Fresnel mirror, or a light guide plate.

FIG. 10 is a plan view of the lens array 3 included in the display switching device 10 or 10a.

As shown in FIG. 10, the lens array 3 included in the display switching device 10 or 10a includes cylindrical lenses arranged one-dimensionally (1D) as microlenses L0 to L4. The microlenses adjacent to the microlens L2 are the microlens L1 and the microlens L3 in an adjacent region RR. The display switching device 10 or 10a may use, for example, the microlenses L1 and L2 adjacent to each other or the microlenses L2 and L3 adjacent to each other to focus light from the light source 1A and light from the light source 2A onto the pixel region 4A or 4A′ or use the microlenses L1 to L3 adjacent to each other to focus light from the light source 1A and light from the light source 2A onto the pixel region 4A or 4A′.

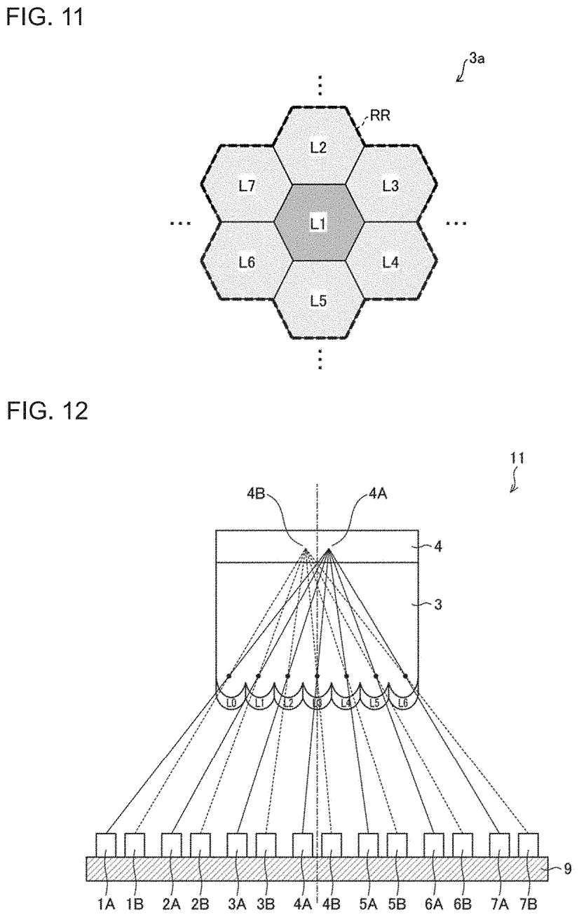

FIG. 11 is a plan view of another example lens array 3a for the display switching device 10 or 10a according to the first embodiment.

As shown in FIG. 11, the lens array 3a includes microlenses L1 to L7 arranged in a two-dimensional (2D) honeycomb. The microlenses adjacent to the microlens L1 include at least one of the microlens L2 to L7 in an adjacent region RR. The display switching device 10 or 10a may use, for example, the microlens L1 and at least one of the microlenses L2 to L7 adjacent to each other to focus light from the light source 1A and light from the light source 2A onto the pixel region 4A or 4A′.

A lens array including microlenses arranged in a 2D matrix may also be used as another lens array for the display switching device 10 or 10a. Such a lens array is described in a second embodiment.

FIG. 12 is a schematic diagram of a display switching device according to another modification of the first embodiment.

A display switching device 11 shown in FIG. 12 includes light sources 1A to 7A included in a first light source group and light sources 1B to 7B included in a second light source group. The display switching device 11 includes, as pixel regions, a first pixel region group including a pixel region 4A (first pixel region) and a second pixel region group including a pixel region 4B (second pixel region).

The pixel region 4A (1-1-pixel region) in the first pixel region group in the display switching device 11 shown in FIG. 12 is illuminated with light emitted from the light source 1A (1-1-light source) in the first light source group and focused by a microlens L0 (first lens) in a lens array 3, light emitted from the light source 2A (1-2-light source) in the first light source group and focused by a microlens L1 (second lens) in the lens array 3, light emitted from the light source 3A (1-3-light source) in the first light source group and focused by a microlens L2 (third lens) in the lens array 3, light emitted from the light source 4A (1-4-light source) in the first light source group and focused by a microlens L3 (fourth lens) in the lens array 3, light emitted from the light source 5A (1-5-light source) in the first light source group and focused by a microlens L4 (fifth lens) in the lens array 3, light emitted from the light source 6A (1-6-light source) in the first light source group and focused by a microlens L5 (sixth lens) in the lens array 3, and light emitted from the light source 7A (1-7-light source) in the first light source group and focused by a microlens L6 (seventh lens) in the lens array 3. In the present embodiment or embodiments, the pixel region 4A is illuminated with light from the seven different light sources 1A to 7A through the different microlenses L0 to L6. The above described structure is, however, not limited to the present example.

Similarly, the pixel region 4B (2-1-pixel region) in the second pixel region group in the display switching device 11 shown in FIG. 12 is illuminated with light emitted from the light source 1B (2-1-light source) in the second light source group and focused by the microlens L0 (first lens) in the lens array 3, light emitted from the light source 2B (2-2-light source) in the second light source group and focused by the microlens L1 (second lens) in the lens array 3, light emitted from the light source 3B (2-3-light source) in the second light source group and focused by the microlens L2 (third lens) in the lens array 3, light emitted from the light source 4B (2-4-light source) in the second light source group and focused by the microlens L3 (fourth lens) in the lens array 3, light emitted from the light source 5B (2-5-light source) in the second light source group and focused by the microlens L4 (fifth lens) in the lens array 3, light emitted from the light source 6B (2-6-light source) in the second light source group and focused by the microlens L5 (sixth lens) in the lens array 3, and light emitted from the light source 7B (2-7-light source) in the second light source group and focused by the microlens L6 (seventh lens) in the lens array 3. In the present embodiment or embodiments, the pixel region 4B is illuminated with light from the seven different light sources 1B to 7B through different microlenses L0 to L6. The above described structure is, however, not limited to the present example. The display switching device 11 has more display uniformity across each of the pixel region 4A (first pixel region) and the pixel region 4B (second pixel region). The display switching device 11 also has more luminance uniformity between the pixel region 4A (first pixel region) and the pixel region 4B (second pixel region). The display switching device 11 can thus be larger and thinner.

As shown in FIG. 12, the light source 1A (1-1-light source) included in the first light source group and the light source 1B (2-1-light source) included in the second light source group are located in a first area. The light source 2A (1-2-light source) included in the second light source group and the light source 2B (2-2-light source) included in the second light source group are located in a second area. The first area and the second area are adjacent to each other. The same applies to the light sources 3A to 7A included in the first light source group and the light sources 3B to 7B included in the second light source group.

The display switching device 11 may simply turn on, for example, the light sources 6A and 7A included in the first light source group and the light sources 6B and 7B included in the second light source group, or the light sources 1A and 2A included in the first light source group and the light sources 1B to 2B included in the second light source group to allow bright appearance at specific angles. For example, the display switching device 11 may simply include the light sources 6A and 7A included in the first light source group and the light sources 6B and 7B included in the second light source group, or the light sources 1A and 2A included in the first light source group and the light sources 1B to 2B included in the second light source group on the substrate 9 to allow bright appearance at specific angles.

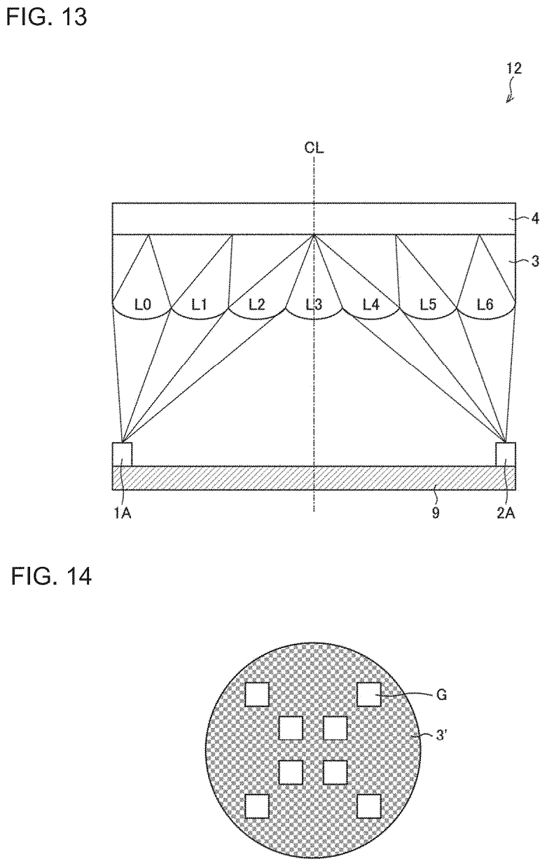

FIG. 13 is a schematic diagram of a display switching device according to still another modification of the first embodiment.

A display switching device 12 shown in FIG. 13 includes a display unit 4 (the display unit 4 in FIG. 6) divided into sections illuminated by the light sources 1A and 2A included in the first light source group. The display switching device 12 includes the display unit 4 divided into, for example, five sections for illumination. Around the center CL of the display unit 4, light from two light sources 1A and 2A is focused. In the area leftward from the center CL of the display unit 4, light from the light source 1A is focused. In the area rightward from the center CL of the display unit 4, light from the light source 2A is focused. In the display switching device 12 shown in FIG. 13, light from the light source 1A and light from the light source 2A are focused on one point. However, light from the light source 1A and light from the light source 2A may be focused on multiple points. In the display switching device 12 shown in FIG. 13, light from the two light sources 1A and 2A is focused near the center CL of the display unit 4. However, light from the two light sources 1A and 2A may be focused on any position, such as on a dividing line dividing the display unit 4 as appropriate, rather than near the center CL of the display unit 4. The display switching device 12 shown in FIG. 13 may include a lens array 3 eliminating a microlens L3 located near the position on which light from the light sources 1A and 2A is focused. In another example, the microlens L3 may be printed with a light-shielding material or shielded by, for example, a light-shield wall below.

FIG. 14 is a plan view of still another example lens array 3′ included in the display switching device according to the first embodiment.

As shown in FIG. 14, the lens array 3′ may be circular. The lens array 3′ may have an area larger than the area receiving multiple light sources G.

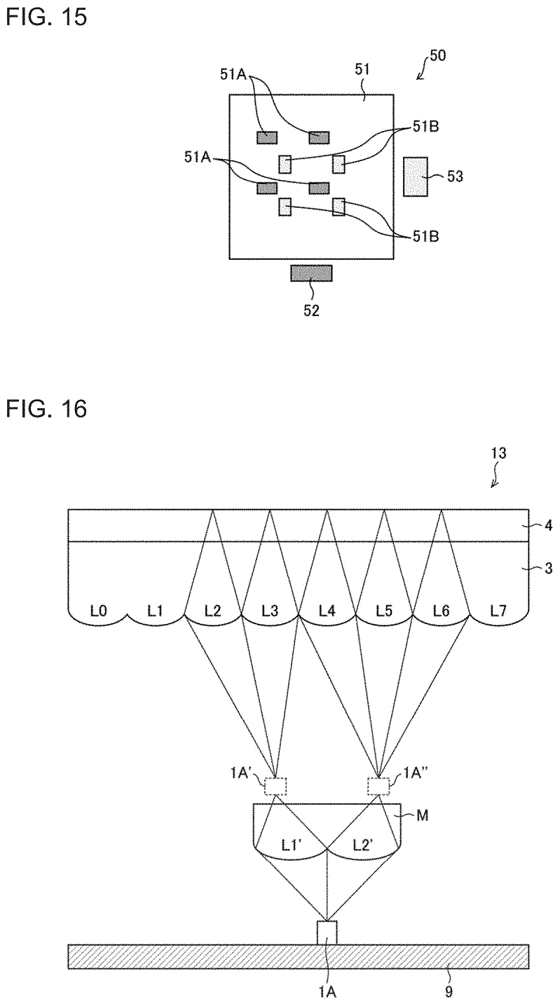

FIG. 15 is a diagram of other example light sources for the display switching device according to the first embodiment.

A light guide 50 shown in FIG. 15 includes a light source 52, a light source 53, and a light guide plate 51. The light guide plate 51 includes reflectors 51A for causing light from the light source 52 to be emitted and reflectors 51B for causing light from the light source 53 to be emitted. More specifically, in the light guide 50, the light sources 52 and 53 use the respective reflectors 51A and 51B as their virtual light sources, and may emit light having the same color or different colors of light. The display switching device 10, 10a, 11, or 12 described above may include the light guide 50 in place of the light sources and the substrate.

FIG. 16 is a diagram of still other example light sources for the display switching device according to the first embodiment.

In the display switching device 13 shown in FIG. 16, multiple light sources including a light source 1A may include virtual light sources 1A′ and 1A″ generated by a lens M including a microlens L1′ and a microlens L2′ using a portion of light from a real light source (light source 1A) that actually emits light. A structure including virtual light sources uses fewer real light sources. The display switching device 13 with the above described structure is also energy-saving.

In the present embodiment or embodiments, the lens M is used to generate the virtual light sources 1A′ and 1A″ with a portion of light from the real light source (light source 1A) that actually emits light. However, the above described structure is not limited to the present example. A mirror M′ may be used to generate virtual light sources with a portion of light from a real light source that actually emits light, as in a second embodiment described below.

### Second Embodiment

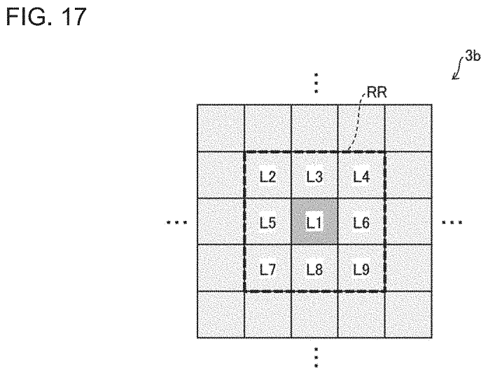

The second embodiment will now be described with reference to FIGS. 17, 18, 19, 20, 21, 22, 23, 24, 25, and 26. A display switching device 14, 14a, 15, 16, 17, or 18 in the present embodiment or embodiments differs from the display switching device according to the first embodiment described above in its lens array 3b including microlenses arranged in a 2D matrix. The other details are the same as in the first embodiment. For ease of explanation, the components with the same functions as the components shown in the figures for the first embodiment are given the same reference numerals and will not be described.

FIG. 17 is a schematic plan view of the lens array 3b included in a display switching device according to the second embodiment.

As shown in FIG. 17, the lens array 3b includes microlenses arranged in a 2D matrix. The microlenses adjacent to a microlens L1 include at least one of microlenses L2 to L9 in an adjacent region RR. In the display switching device 14, 14a, 15, 16, 17, or 18 described below, for example, the microlens L1 and at least one of the microlenses L2 to L9 adjacent to each other may be used to focus light from multiple light sources G1C to G9C, G1D to G9D, G1E to G9E, and G1F to G9F onto the pixel regions 4C to 4F.

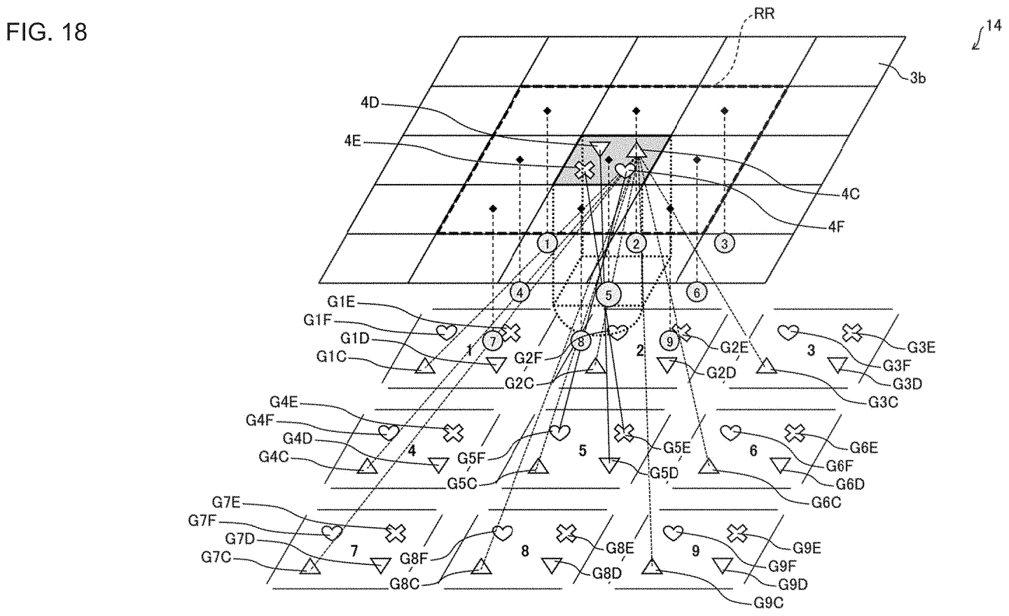

FIG. 18 is a schematic diagram of the display switching device 14 according to the second embodiment.

The display switching device 14 shown in FIG. 18 includes 36 light sources in total including nine light sources G1C to G9C included in a first light source group, nine light sources G1D to G9D included in a second light source group, nine light sources G1E to G9E included in a third light source group, and nine light sources G1F to G9F included in a fourth light source group.

Light from the nine light sources G1C to G9C included in the first light source group is focused onto the pixel region 4C (first pixel region) each through a different microlens (indicated with reference numerals 1 to 9 in circles in the figure). Light from the nine light sources G1D to G9D included in the second light source group is focused onto the pixel region 4D (second pixel region) each through a different microlens (indicated with reference numerals 1 to 9 in circles in the figure). Light from the nine light sources G1E to G9E included in the third light source group is focused onto the pixel region 4E (third pixel region) each through a different microlens (indicated with reference numerals 1 to 9 in circles in the figure). Light from the nine light sources G1F to G9F included in the fourth light source group is focused onto the pixel region 4F (fourth pixel region) each through a different microlens (indicated with reference numerals 1 to 9 in circles in the figure).

As shown in FIG. 18, for example, the nine light sources G1C to G9C included in the first light source group each are on the extension from the intersection between the pixel region 4C and the center of the corresponding one of the microlenses (indicated with reference numerals 1 to 9 in circles in the figure). The nine light sources G1D to G9D included in the second light source group each are on the extension from the intersection between the pixel region 4D and the center of the corresponding one of the microlenses (indicated with reference numerals 1 to 9 in circles in the figure). The nine light sources G1E to G9E included in the third light source group each are on the extension from the intersection between the pixel region 4E and the center of the corresponding one of the microlenses (indicated with reference numerals 1 to 9 in circles in the figure). The nine light sources G1F to G9F included in the fourth light source group each are on the extension from the intersection between the pixel region 4F and the center of the corresponding one of the microlenses (indicated with reference numerals 1 to 9 in circles in the figure).

The display switching device 14 includes the lens array 3b shown in FIG. 17 including the microlenses L1 to L9 to display four static patterns (pixel regions 4C to 4F) with the 36 light sources. More specifically, one static pattern is displayed with nine light sources.

The above described structure improves the display uniformity across each of the pixel regions 4C to 4F. The above described structure also improves the luminance uniformity across each of the pixel regions 4C to 4F. The display switching device 14 can thus be larger and thinner.

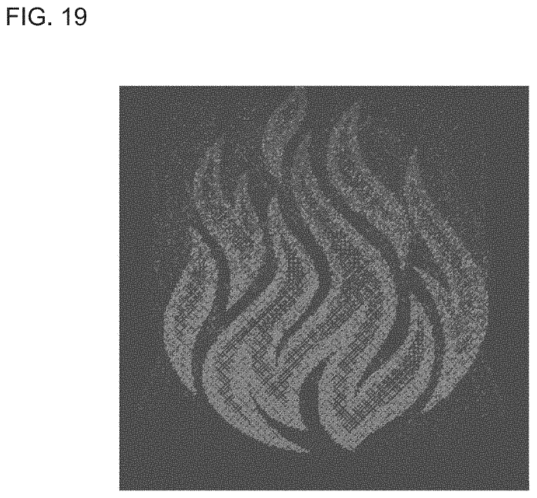

FIG. 19 is a diagram of example display appearing on the pixel regions in the display switching device according to the second embodiment, with multiple light sources that emit different colors of light.

The multiple light sources may include a set of upper light sources and a set of lower light sources in the figure each emitting light with a different color, which allows display of a gradation of colors in the vertical direction. The figure shows a flame-like pattern. The design includes a flame represented with changing colors from bottom to top.

The display switching device 14 shown in FIG. 18 may include, for example, at least one of the nine light sources G1C to G9C included in the first light source group emitting light with a color different from the color of light emitted by the other light sources, with light with a different color focused onto the pixel region 4C. The display switching device 14 can thus display a new appearance.

In FIG. 19, the static pattern for the pixel region 4C represents a flame.

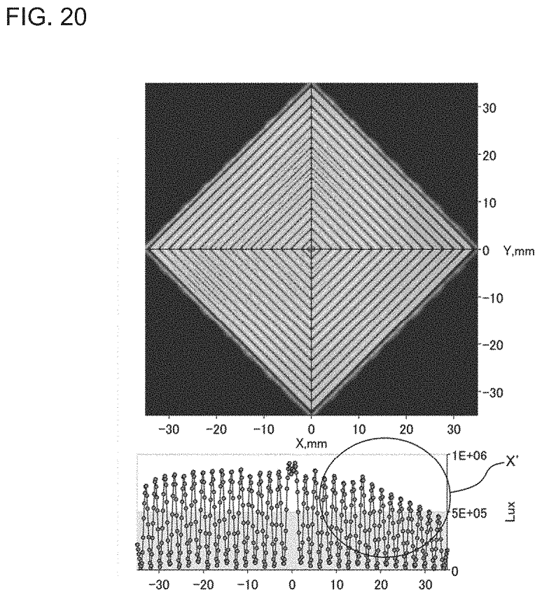

FIG. 20 is a diagram describing display uniformity across the pixel regions in the display switching device according to the second embodiment, with multiple light sources that emit light at the same intensity. FIG. 21 is a diagram describing display uniformity across the pixel regions in the display switching device according to the second embodiment, with multiple light sources that emit light at different intensities.

For example, the display switching device 14 shown in FIG. 18 may control at least one of the nine light sources G1C to G9C included in the first light source group to have an intensity (emission intensity) different from the intensity of the other light sources. Accordingly, as shown in FIG. 21, the pixel region 4C may have more display uniformity than X′ portion in FIG. 20.

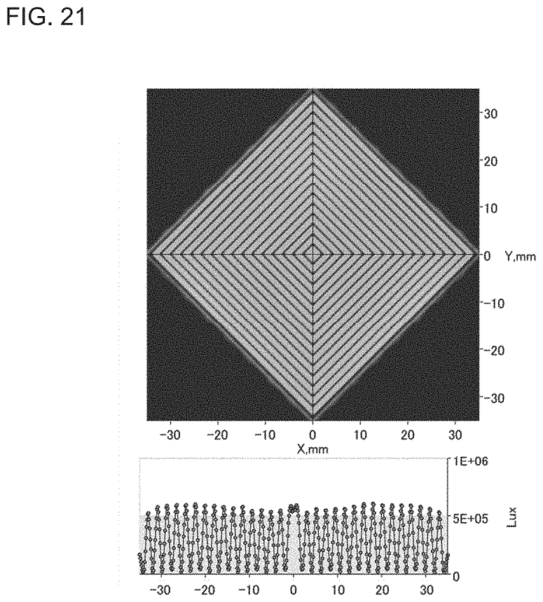

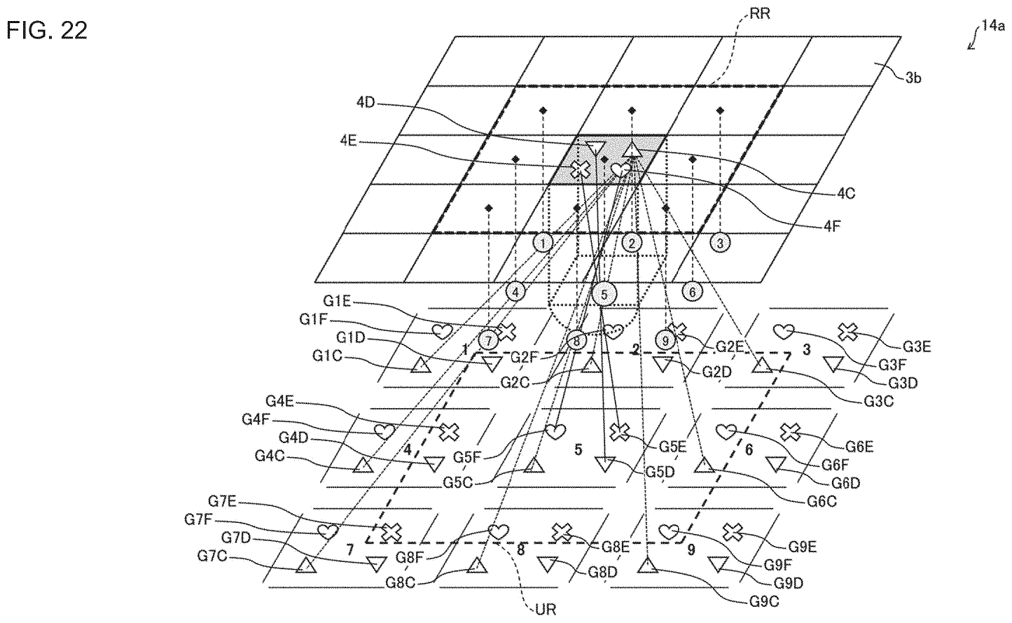

FIG. 22 is a schematic diagram of a display switching device according to a first modification of the second embodiment.

As shown in FIG. 22, the display switching device 14a uses 16 light sources in a usable area UR alone, thus using light focused by four microlenses adjacent to each other. Although the display switching device 14a shown in FIG. 22 uses 16 light sources of the 36 light sources, the above described structure is not limited to the present example. The display switching device 14a may simply include 16 light sources to be used. The display switching device 14a may use any number of light sources determined as appropriate, rather than 16 light sources. Light from each of the four light sources G2C, G3C, GSC, and G6C included in the first light source group in the usable area UR is focused on the pixel region 4C through a different one of the microlenses (indicated with reference numerals 2, 3, 5, and 6 in circles in the figure) adjacent to each other. Light from each of the four light sources G1D, G2D, G4D, and G5D included in the second light source group in the usable area UR is focused on the pixel region 4D through a different one of the microlenses (indicated with reference numerals 1, 2, 4, and 5 in circles in the figure) adjacent to each other. Light from each of the four light sources G4E, GSE, G7E, and G8E included in the third light source group in the usable area UR is focused on the pixel region 4E through a different one of the microlenses (indicated with reference numerals 4, 5, 7, and 8 in circles in the figure) adjacent to each other. Light from each of the four light sources GSF, G6F, G8F, and G9F included in the fourth light source group in the usable area UR is focused on the pixel region 4F through a different one of the microlenses (indicated with reference numerals 5, 6, 8, and 9 in circles in the figure) adjacent to each other.

The display switching device 14a has more display uniformity across the pixel regions with multiple relatively small optical systems.

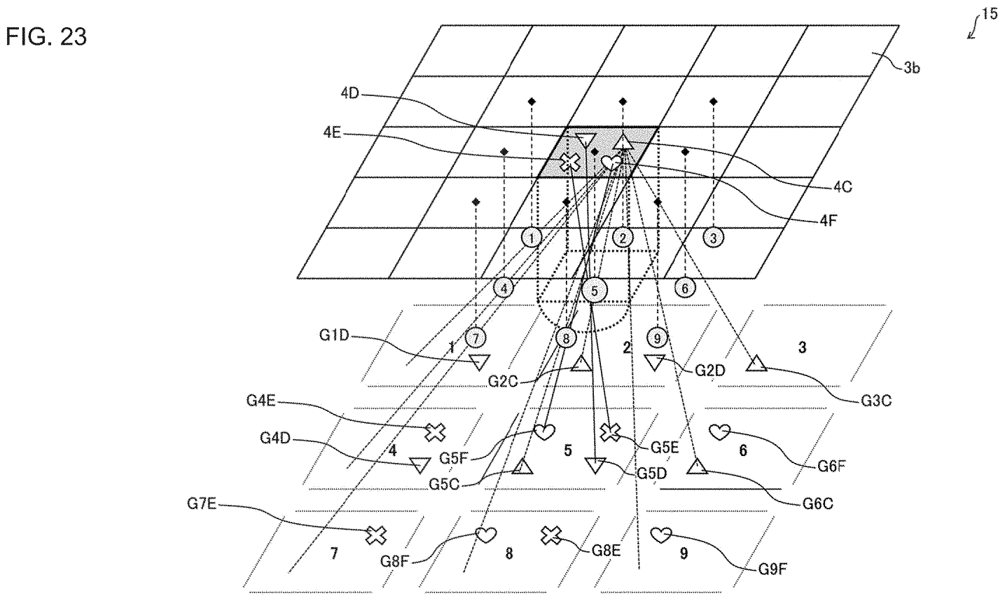

FIG. 23 is a schematic diagram of a display switching device according to a second modification of the second embodiment.

The display switching device 15 shown in FIG. 23 differs from the display switching device 14a shown in FIG. 22 in its 16 light sources in the usable area UR shown in FIG. 22. The other details are the same as in the display switching device 14a shown in FIG. 22.

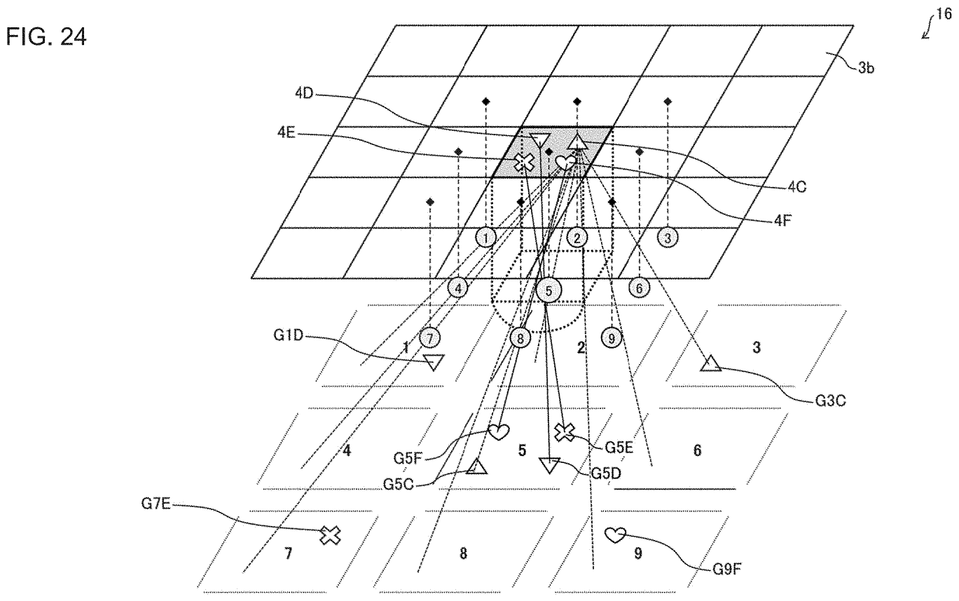

FIG. 24 is a schematic diagram of a display switching device according to a third modification of the second embodiment.

The display switching device 16 shown in FIG. 24 includes still fewer light sources, or more specifically, eight light sources. Light from each of two light sources G3C and G5C included in the first light source group is focused onto the pixel region 4C through a different microlens (indicated with reference numeral 3 or 5 in a circle in the figure). Light from each of two light sources G1D and G5D included in the second light source group is focused onto the pixel region 4D through a different microlens (indicated with reference numeral 1 or 5 in a circle in the figure). Light from each of two light sources G5E and G7E included in the third light source group is focused onto the pixel region 4E through a different microlens (indicated with reference numeral 5 or 7 in a circle in the figure). Light from each of two light sources G5F and G9F included in the fourth light source group is focused onto the pixel region 4F through a different microlens (indicated with reference numeral 5 or 9 in a circle in the figure).

The display switching device 16 has more display uniformity across the pixel regions with multiple relatively small optical systems. The display switching device 16 uses still fewer light sources.

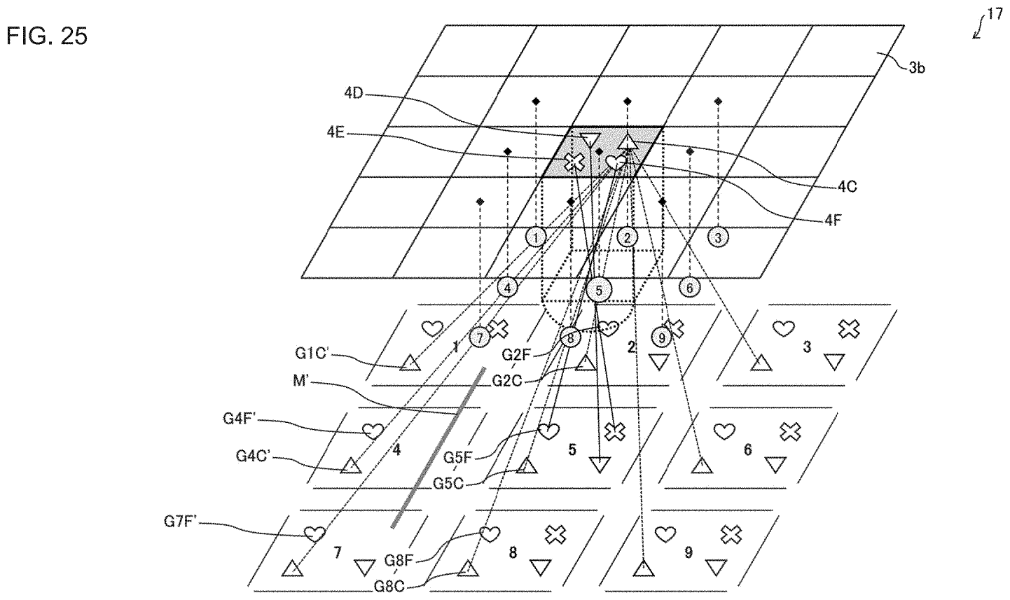

FIG. 25 is a schematic diagram of a display switching device according to a fourth modification of the second embodiment.

The display switching device 17 shown in FIG. 25 uses a mirror M′ to generate virtual light sources using a portion of light from real light sources that actually emit light. As shown in FIG. 25, the mirror M′ generates virtual light sources G1C′, G4F′, G4C′, and G7F′ using a portion of light from real light sources G2C, GSF, GSC, and G8F that actually emit light.

The display switching device 17 with the above described structure includes fewer real light sources and is energy-saving.

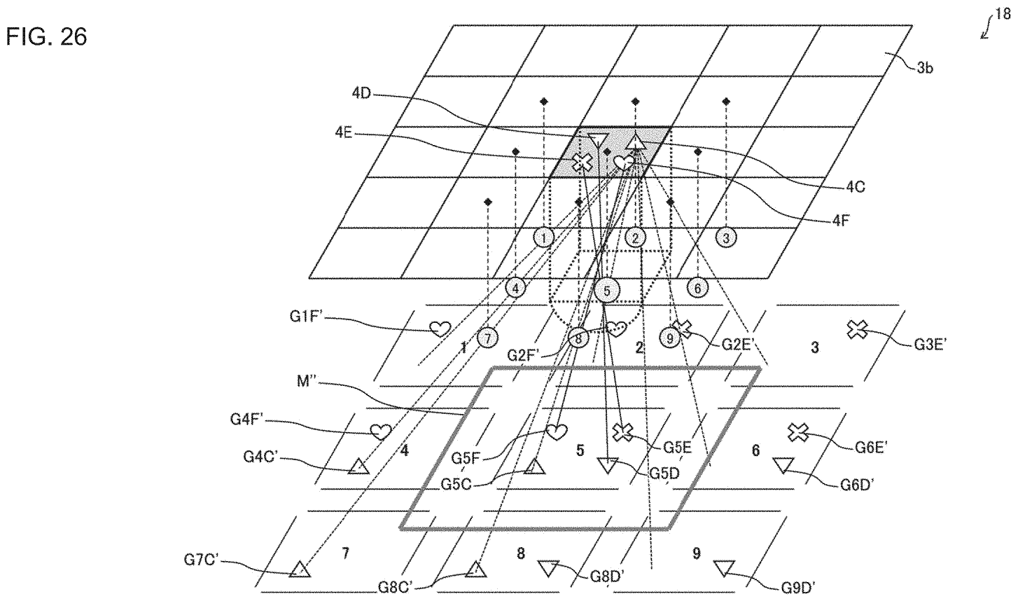

FIG. 26 is a schematic diagram of a display switching device according to a fifth modification of the second embodiment.

The display switching device 18 shown in FIG. 26 uses a mirror frame M″ to generate virtual light sources using a portion of light from real light sources that actually emit light. As shown in FIG. 26, the mirror frame M″ generates virtual light sources G1F′, G2F′, G2E′, G3E′, G4F′, G4C′, G6E′, G6D′, G7C′, G8C′, G8D′, and G9D′ using a portion of light from real light sources GSC, GSD, G5E, and G5F that actually emit light.

The display switching device 18 with the above described structure includes fewer real light sources and is energy-saving.

### Third Embodiment

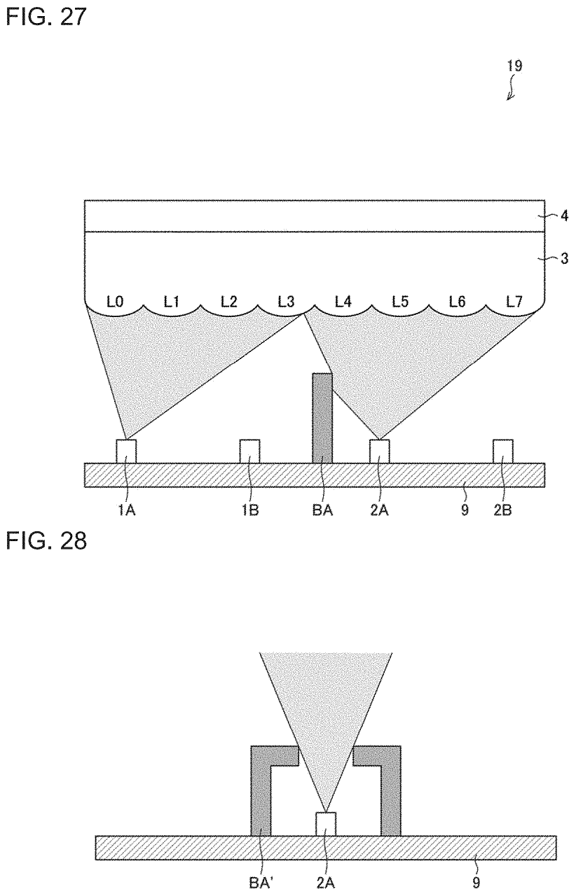

A third embodiment will now be described with reference to FIGS. 27 and 28. A display switching device 19 according to the present embodiment or embodiments differs from the display switching device according to the first or second embodiment in including a light-shield wall BA. The other details are the same as in the first and second embodiments. For ease of explanation, the components with the same functions as the components shown in the figures for the first and second embodiments are given the same reference numerals and will not be described.

FIG. 27 is a schematic diagram of the display switching device 19 according to the third embodiment.

The display switching device 19 shown in FIG. 27 further includes the light-shield wall BA that shields a part of an area defined by the emission angle of light emitted from a light source 2A.

The display switching device 19 with the above described structure can block light entering at wide angles with the light-shield wall BA, thus avoiding image quality degradation resulting from aberration.

FIG. 28 is a diagram of another example light-shield wall BA′ for the display switching device according to the third embodiment.

As shown in FIG. 28, the light-shield wall BA′ surrounds the light source 2A, with an opening in the area defined by the emission angle of light.

### Fourth Embodiment

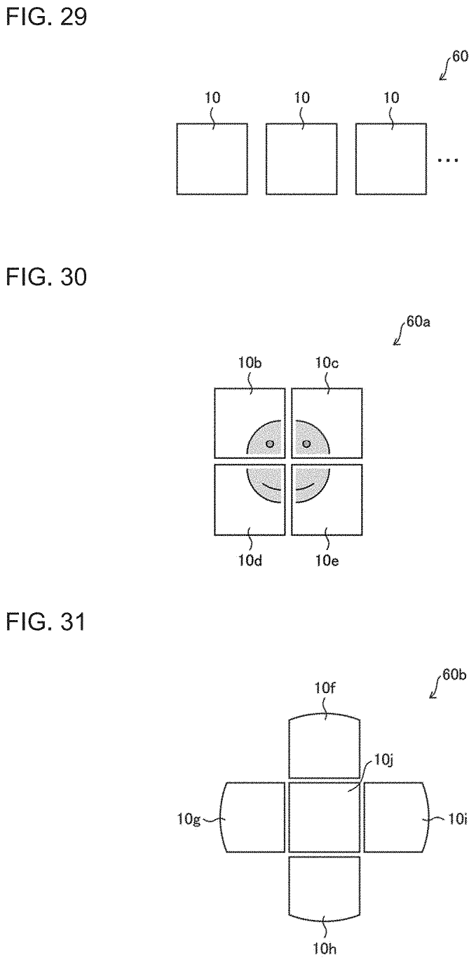

A fourth embodiment will now be described with reference to FIGS. 29, 30, 31, 32, 33, and 34. A display switching system 60, 60a, 60b, or 60c according to the present embodiment or embodiments includes multiple display switching devices according to any one of the first to third embodiments described above. For ease of explanation, the components with the same functions as the components shown in the figures for the first to third embodiments are given the same reference numerals and will not be described.

FIG. 29 is a schematic diagram of the display switching system 60 according to the fourth embodiment.

The display switching system 60 shown in FIG. 29 includes multiple display switching devices 10 joined laterally or vertically to have the display units in the display switching devices 10 adjacent to each other.

FIG. 30 is a schematic diagram of a display switching system according to a modification of the fourth embodiment.

The display switching system 60a shown in FIG. 30 includes multiple display switching devices 10b, 10c, 10d, and 10e joined two-dimensionally to have the display units in the display switching devices adjacent to each other.

FIG. 31 is a schematic diagram of a display switching system according to another modification of the fourth embodiment.

The display switching system 60b shown in FIG. 31 includes multiple display switching devices 10f, 10g, 10h, 10i, and 10j joined in any arrangement to have the display units in the display switching devices adjacent to each other.

The display switching system 60, 60a, or 60b with the corresponding structure allows display of larger images or images with any shapes.

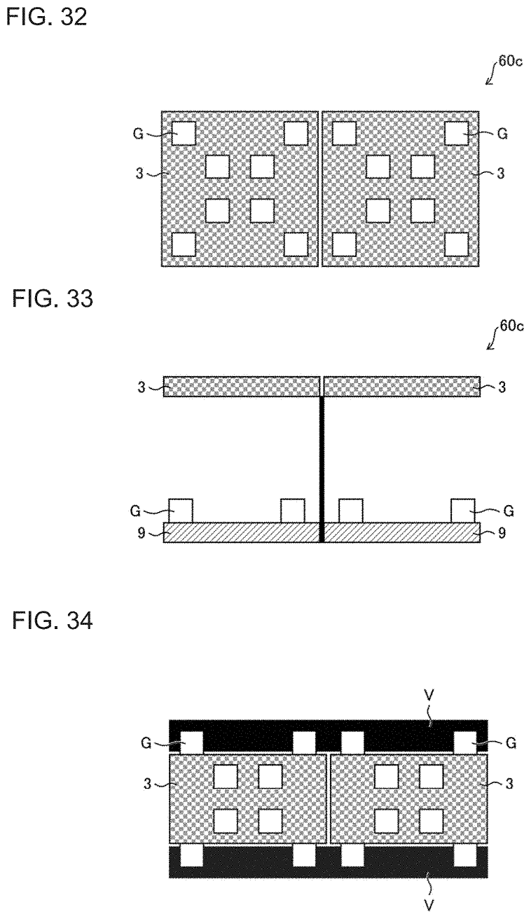

FIG. 32 is a schematic plan view of a bezel-less display switching system 60c. FIG. 33 is a cross-sectional view of the bezel-less display switching system 60c shown in FIG. 32.

The bezel-less display switching system 60c shown in FIGS. 32 and 33 includes multiple display switching devices. Each display switching device has an area for the lens array 3 greater than the area receiving multiple light sources G. The bezel-less display switching system 60c with the above described structure includes multiple display switching devices joined together without additional bezels (in a bezel-less manner).

FIG. 34 is a schematic plan view of a display switching system with a bezel.

As shown in FIG. 34, the display switching system having an area for the lens array 3 smaller than the area receiving multiple light sources G additionally uses bezels V, and thus is not bezel-less.

### Fifth Embodiment

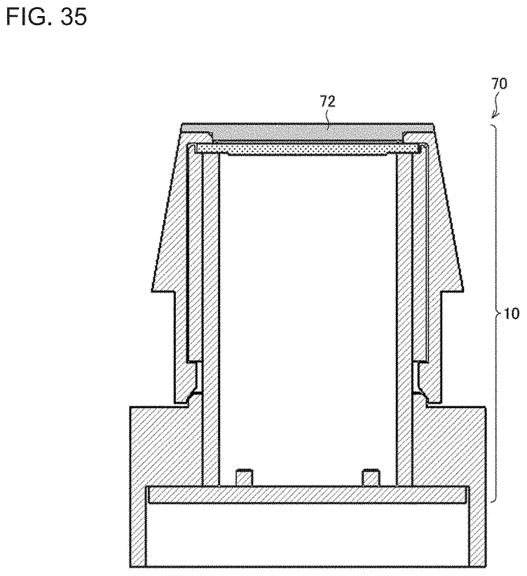

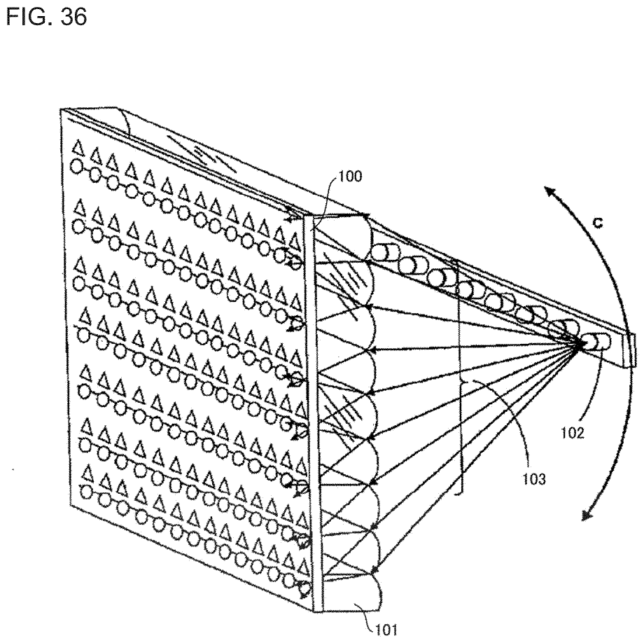

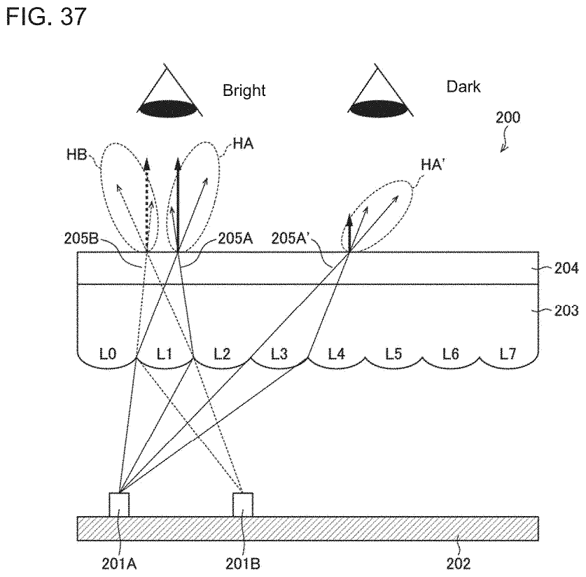

A fifth embodiment will now be described with reference to FIG. 35. In the present embodiment or embodiments, a switch 70 including the display switching device 10 will be described. For ease of explanation, the components with the same functions as the components shown in the figures for the first to fourth embodiments are given the same reference numerals and will not be described.

FIG. 35 is a schematic diagram of the switch 70 according to the fifth embodiment including the display switching device 10.

As shown in FIG. 35, the switch 70 may further include a light absorber 72 that absorbs external light. The light absorber 72 overlaps the portion of the display unit 4 other than the pixel regions in the display switching device 10 in a plan view.

Although not shown, a display switching device or a display switching system that includes static patterns representing ON and OFF may have the function of detecting a user operation on the display switching device or the display switching system to be used as a switch.

The switch with the above described structure may have more uniformity across the pixel regions.

An electrical apparatus including the switch described above is operated with the switch.

The electrical apparatus with the above described structure may have more display uniformity on the surface of each switch or button or on a display screen included in the electrical apparatus. Examples of the electrical apparatus include, but are not limited to, game machines, in-vehicle devices, household electrical equipment, and elevators.

The embodiments described herein should not be construed to be restrictive, but may be modified within the spirit and scope of the claimed disclosure. The technical features disclosed in different embodiments may be combined in other embodiments within the technical scope.

1. A display switching device for switching display images by switching light illumination from a plurality of light source groups each comprising a plurality of light sources between the plurality of light source groups, the device comprising:
a lens array comprising a plurality of lenses; and
a display unit comprising a plurality of pixel regions, the plurality of pixel regions being configured to allow passage of light emitted from the plurality of light source groups and focused by the plurality of lenses comprised in the lens array, wherein
each of the plurality of pixel regions has a transmittance corresponding to a predetermined static pattern, and
at least one of the pixel regions receives light from the plurality of light sources comprised in a predetermined light source group of the plurality of light source groups, and the light from each of the plurality of light sources in the predetermined light source group is focused by a different lens of the plurality of lenses.

2. The display switching device according to claim 1, wherein
the plurality of light source groups comprise at least a first light source group and a second light source group,
the plurality of pixel regions comprise at least a first pixel region group and a second pixel region group,
the first pixel region group comprises a 1-1-pixel region configured to receive illumination of light emitted from a 1-1-light source in the first light source group and focused by a first lens in the lens array and to receive illumination of light emitted from a 1-2-light source in the first light source group and focused by a second lens in the lens array, and
the second pixel region group comprises a 2-1-pixel region configured to receive illumination of light emitted from a 2-1-light source in the second light source group and focused by the first lens and to receive illumination of light emitted from a 2-2-light source in the second light source group and focused by the second lens.

3. The display switching device according to claim 2, wherein
the 1-1-light source and the 2-1-light source are in a first area, the 1-2-light source and the 2-2-light source are in a second area, and the first area and the second area are adjacent to each other.

4. The display switching device according to claim 2, wherein
the first lens and the second lens are adjacent to each other.

5. The display switching device according to claim 1, wherein
the lens array comprises the plurality of lenses arranged in a two-dimensional matrix, and
at least one of the pixel regions receives illumination of light focused by four of the plurality of lenses adjacent to each other.

6. The display switching device according to claim 1, wherein
the lens array has an area larger than an area receiving the plurality of light sources.

7. The display switching device according to claim 1, wherein
the plurality of light sources comprise a virtual light source generated by a mirror or a lens using a portion of light from a real light source configured to actually emit light.

8. The display switching device according to claim 1, further comprising:
a light shield configured to shield a part of an area defined by an emission angle of light emitted from a light source of the plurality of light sources.

9. The display switching device according to claim 1, wherein
the predetermined light source group comprises the plurality of light sources having different intensities.

10. The display switching device according to claim 1, wherein
the predetermined light source group comprises the plurality of light sources having different emission colors.

11. The display switching device according to claim 1, wherein
the plurality of lenses receive illumination of collimated light.

12. A display switching system, comprising:
a plurality of the display switching devices according to claim 1, wherein
the plurality of display switching devices comprise the display units adjacent to each other.

13. A switch, comprising:
the display switching device according to claim 1, wherein
the switch detects a user operation on the display switching device.

14. An electrical apparatus, comprising:
the switch according to claim 13, wherein
the electrical apparatus is operable with the switch.

15. The display switching device according to claim 3, wherein
the first lens and the second lens are adjacent to each other.

16. The display switching device according to claim 2, wherein
the lens array comprises the plurality of lenses arranged in a two-dimensional matrix, and
at least one of the pixel regions receives illumination of light focused by four of the plurality of lenses adjacent to each other.

17. The display switching device according to claim 3, wherein
the lens array comprises the plurality of lenses arranged in a two-dimensional matrix, and
at least one of the pixel regions receives illumination of light focused by four of the plurality of lenses adjacent to each other.

18. The display switching device according to claim 4, wherein
the lens array comprises the plurality of lenses arranged in a two-dimensional matrix, and
at least one of the pixel regions receives illumination of light focused by four of the plurality of lenses adjacent to each other.

19. The display switching device according to claim 2, wherein
the lens array has an area larger than an area receiving the plurality of light sources.

20. The display switching device according to claim 3, wherein
the lens array has an area larger than an area receiving the plurality of light sources.
